(19) United States
(12) Patent Application Publication
(10) Pub. No.: US 2005/0282425 A1
(43) Pub. Date: Dec. 22, 2005

(54) Selectively releaseable connector module assembly

(76) Inventors: Brian Keith Lloyd, Maumelle, AR (US); William A. Russell JR., Maumelle, AR (US)

Correspondence Address: MOLEX INCORPORATED, 2222 WELLINGTON COURT, LISLE, IL, 60532, US

(21) Appl. No.: 11/141,071

(22) Filed: May 31, 2005

Related U.S. Application Data
(60) Provisional application No. 60/575,358, filed on May 28, 2004.

(51) Int. Cl. H01R 13/62

(52) U.S. Cl. 439/372

(57) ABSTRACT

A connector module for use with a shielded housing uses a lever-actuated wedge member to lift a flexible locking tab of the shielded housing over a locking pin of the connector module. The wedge member has a pointed end that faces the locking pin so that the wedge member can be slid between the connector module and the shielded housing flexible tab that engages the locking pin. The wedge member is moved by way of a lever within the connector module and which pivots about a fulcrum in the connector module. Moving the lever one direction moves the wedge member in an opposite direction.

### REFERENCE TO RELATED APPLICATIONS

This application claims priority from prior U.S. Provisional Patent Application No. 60/575,358 filed May 28, 2005.

### BACKGROUND OF THE INVENTION

The present invention relates generally to connector modules that are inserted into shielding cages for connection to circuit boards, and more particularly to modules and related assemblies that include a mechanism associated with the module that may be actuated to disengage the module from engagement with an associated shielding cage.

Communications switching equipment frequently uses plug-in modules, usually embodied as small housings that enclose one or more circuits and/or circuit boards. An edge connector that extends from one end of a plug-in module, engages a complementary connector in the chassis or housing of the switching equipment. An indicator, control device or a connector at the opposite end of the plug-in module usually provides some sort of connection or interface between the switching equipment into which the plug-in module is connected.

In the prior art, plug-in modules are usually latched in place after they are installed. Whenever it becomes necessary or desirable to remove a plug-in module, de-latching a module may be problematic because most latching connectors used in these so-called connector-latching housings are not designed to be easily removed. A plug-in module must often be pried out of engagement. A de-latching connector for a plug-in module that provides a mechanism for being de-latched from a connector-latching housing would be an improvement over the prior art.

### SUMMARY OF THE INVENTION

It is therefore a general object of the preset invention to provide a connector module assembly that has a delatching mechanism incorporated within its structure that may be actuated to easily remove the module from an associated cage.

Another object of the present invention is to provide an improved module of the electrical or optical nature that has an engagement member for engaging a surrounding cage, and a mechanism that contacts the cage to disengage the engagement member from the cage to thereby permit removal of the module from the cage.

A further object of the present invention is to provide a module with an engagement lug for engaging a cage into which the module is inserted, the module including a mechanism for disengaging the engagement lug from engagement with the cage so that the module may be removed from the cage, the module mechanism including a wire handle that is rotatable between two positions, and in which in one of the two positions, the bail may be pulled to actuate the delatching mechanism.

Yet another object of the present invention is to provide a release mechanism for disengaging a module from a cage in which the module is held, the module including an engagement tab extend out from an exterior surface of the module and being received within an opening formed in a portion of the cage, the release mechanism including an actuator that is pivotally mounted within the module, the actuator being operatively connected to a cam member and a tie bar that engages a portion of the interior of the module and which extends out of the module, the tie bar pivotally supporting a wire bail that serves as a handle for the module release mechanism.

Still yet another object of the present invention is to provide a module release mechanism of the type described above wherein the release mechanism utilizes a resilient tie bar that engages the interior of the module, the tie bar being stretchable between first and second operative positions the resiliency of the tie bar providing a means for returning the tie bar to its first operative position after the module has been released from engagement with the module and the release mechanism.

These and other objects and advantages of the present invention are accomplished by way of the invention's unique structure.

In one principal aspect of the present invention, a releaseable connector module for use with a connector-latching housing is provided with a locking member, preferably in the form of a pin, or lug, that will engage an opening formed in a flexible tab in the connector housing, which typically will take the form of a shielding cage, and the connector also provides a cam member that preferably takes the form of a movable wedge that can release the connector from the housing. The wedge has a pointed end that faces the locking pin and the wedge may be moved toward the locking pin and under a flexible tab that engages the locking pin, thereby lifting the flexible tab above the locking pin allowing the de-latching connector to be removed.

In a first position, the de-latching wedge is located away from the locking pin. In operation, the wedge is moved from its first position away from the locking pin, to a second position toward the locking pin and under the flexible tab. The wedge is moved to the second position by pulling on an external bail that is connected to a beam, one end of which is coupled to one end of a lever that rotates about a fulcrum. The opposite end of the lever is coupled to the blunt end of the wedge. Moving the bail in one direction therefore moves the wedge in an opposite direction. In the preferred embodiment, moving the bail away from the de-latching connector moves the wedge toward the locking pin, pushing the flexible locking tab “upward” and above the locking pin so that the locking pin can clear the flexible tab.

In another principal aspect of the present invention, the connector module include a mechanism for selectively releasing the connector module from engagement with its surrounding shield cage. The mechanism is operatively connected to the interior of the module and has a handle that extends exterior of the module to provide a member for an user to grasp. Pulling on this handle causes the release mechanism to move into contact with the shielding cage and move its engagement tab out of engagement with the connector module. The handle is positioned such that pulling on it not only applies the release force against the shielding cage, but also pulls the connector out of the shielding cage.

The release mechanism includes a base that is slidable within the interior of the connector module. A wire handle in the form of a bail is connected to one end of the base and the other end of the base is connected to a tie bar that connects the base to structure within the interior of the connector module. The tie bar is preferably formed form a resilient material so that it stretches (or elongates) when a pulling force is applied to the wire bail handle. The resiliency of the tie bar provides a means for returning the tie bar backs to its original position within the module when any force on the handle is released.

An actuator is operatively connected to the base proximate to the tie bar. the actuator is pivotally mounted within the module interior, preferably at its midpoint, so that movement of the base will cause the actuator to pivot in a direction generally opposite the direction of a pulling force exerted on the wire bail handle of the mechanism. The actuator supports the aforementioned wedge and the wedge is movably mounted to the actuator so that it moves in response to movement of the actuator.

These and other objects, features and advantages of the present invention will be clearly understood through a consideration of the following detailed description.

### BRIEF DESCRIPTION OF THE DRAWINGS

In the course of this detailed description, the reference will be frequently made to the attached drawings in which:

FIG. 1 is a perspective view of the underside of a connector module constructed in accordance with the principles of the present invention and intended for insertion and removal from an exterior housing;

FIG. 2A is a perspective view of the connector module of FIG. 1, taken from below and with the module partially inserted in a housing which is attached to a circuit board;

FIG. 2B is an enlarged detail view of FIG. 2A, illustrating the connector module engagement member aligned with the latching portion of the housing;

FIG. 3 is the same view as FIG. 1, but illustrating the connector module with the module handle moved to a second position and the de-latching wedge moved to a second position;

FIG. 4 is a perspective view of the internal de-latching mechanism of the connector module of FIG. 1, illustrating the de-latching wedge, lever and bail handle of that mechanism in detail;

FIG. 5 is a perspective view of FIG. 1, with the top half of the connector module removed to reveal the interior thereof and its de-latching mechanism at a rest position;

FIG. 6 is the same view as FIG. 5, but with the de-latching mechanism illustrated at a second, de-latching position;

FIG. 7 is a perspective, sectional view of the connector module of FIG. 1 fully inserted into a housing with the trailing end of the module vertically sectioned to illustrate the de-latching mechanism thereof in its rest position within the housing;

FIG. 8 is the same view as FIG. 7, but illustrating the de-latching mechanism actuated by extending the module bail handle outwardly;

FIG. 9 is a side elevational view illustrating the connector module partially inserted into an exterior housing, but prior to contact with the housing flexible engagement tab by the engagement member of the connector module;

FIG. 10 is the same view as FIG. 9, but with the connector module further advanced into housing where at the module engagement member makes initial contact with the housing engagement tab; and,

FIG. 11 is the same view as FIG. 10, but with the connector module fully inserted into its exterior housing.

### DETAILED DESCRIPTION OF THE PREFERRED EMBODIMENTS

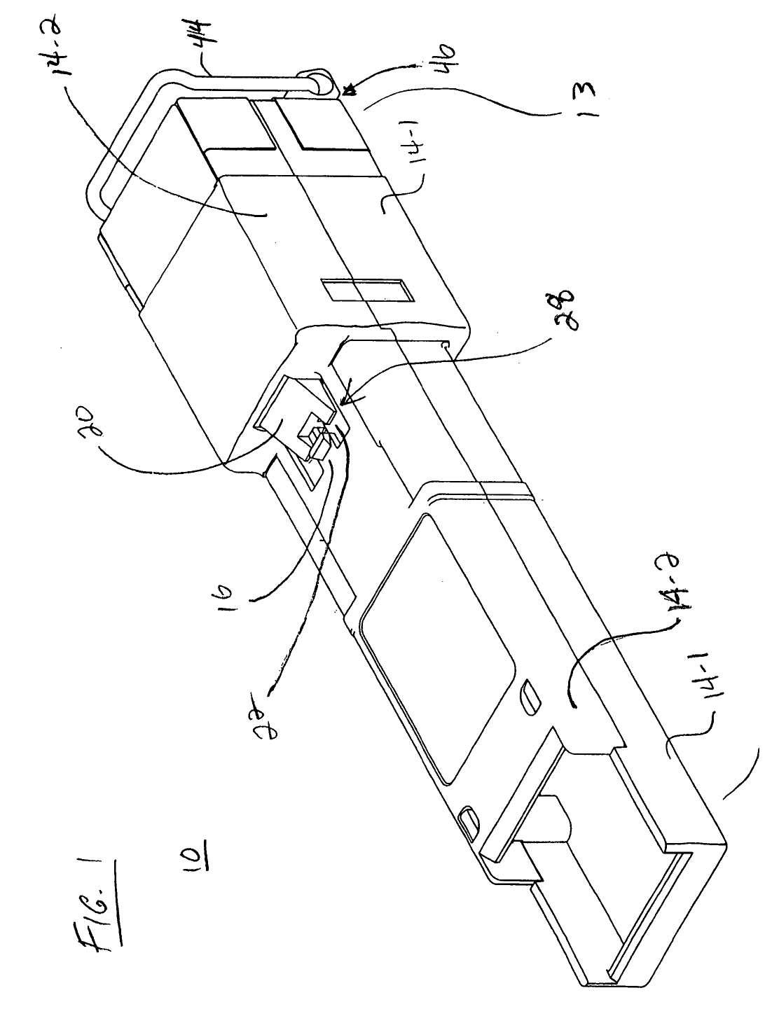

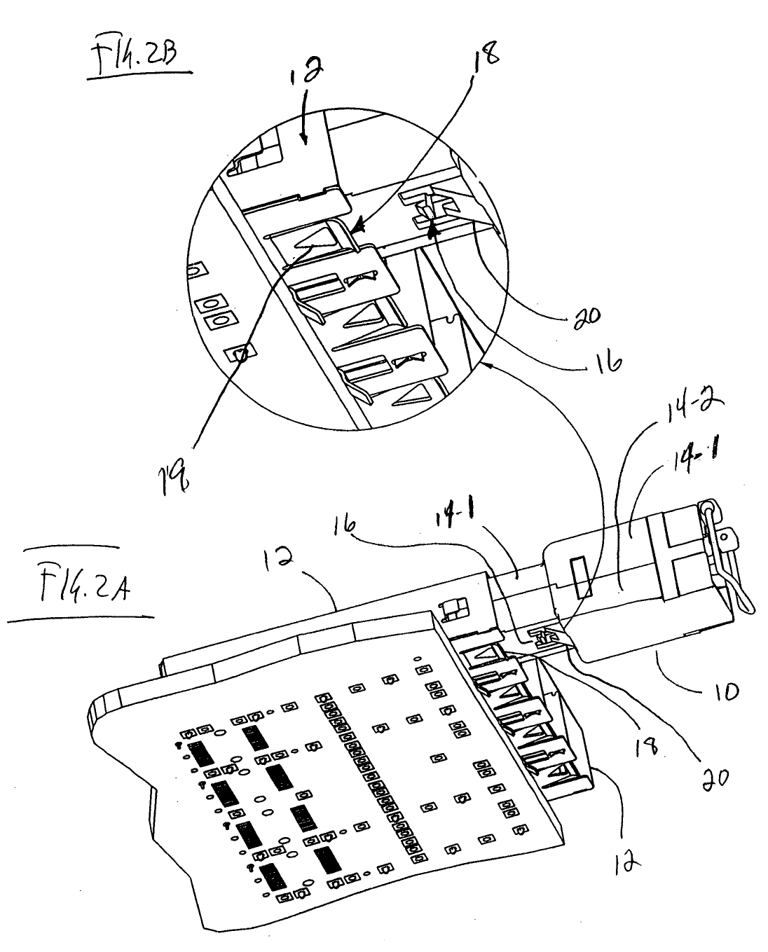

FIG. 1 is a perspective view of a connector module 10 for use with an exterior shielded housing 12 (not shown in FIG. 1 but partially shown in FIG. 2). The connector module 10 is made up of an elongated housing, or body 14 that houses a circuit board and which is assembled from an upper half 14-1 and a lower half 14-2. As shown in FIG. 1, the connector module 10 is inverted, i.e., its bottom or lower half 14-2 is shown as “above” the top or upper half 14-1.

A locking pin 16 protrudes “upwardly” from the (inverted) bottom half 14-2 of the connector module 10 and has a height and width sufficient to engage a flexible, sheet metal tab 18 (not shown in FIG. 1) that is formed in the exterior shielded housing 12 (not shown in FIG. 1). A movable wedge member 20 is shown and it includes a pointed end 22 that faces the module locking pin 16. The wedge member 20 is shown in FIG. 1 in a “first” position 28 that is away from the module locking pin 16. As can be seen in the subsequent figures, the wedge member 20 can be made to slide to its second position 30, which is toward the module locking pin 16 in response to movement of a handle 44, shown in the form of a wire bail, which may be made from a loop of rigid wire that is pivotally mounted in two tie bars 39 that are operatively connected to a lever 32 in the housing body 14.

FIG. 2A shows connector 10 module of FIG. 1, partially inserted into an exterior metal shielding housing 12, and the housing 12 will automatically latch or lock the connector module 10 in place when the connector module 10 is fully inserted into the shielded housing 12. As shown in FIG. 2A, the lower half 14-2 of the housing body 14 is oriented in the shielded housing 12 with the locking pin 16 “down” so that it will engage the flexible sheet metal engagement tab 18 that is formed as part of and which extends out and down from the shielded housing 12.

FIG. 2B shows a more detailed depiction of the relationship between the housing engagement tab 18, the module locking pin 16 and the wedge member 20. As shown in FIG. 2B, the module locking pin 16 slides over a leading edge flap of the housing engagement tab 18 when the module 10 is inserted fully into the shielded housing 12, and in doing so, the engagement tab 18 rides over the module locking pin 16. As the connector module 10 is pushed further into the connector housing 12, the module locking pin 16 falls into and extends through opening 19 in the engagement tab 18. The connector module 10 now cannot be removed from the shielded housing 12 unless the engagement tab 18 is moved over the top of the locking pin 16 so that the connector module 10 can be slid out of the shielded housing 12.

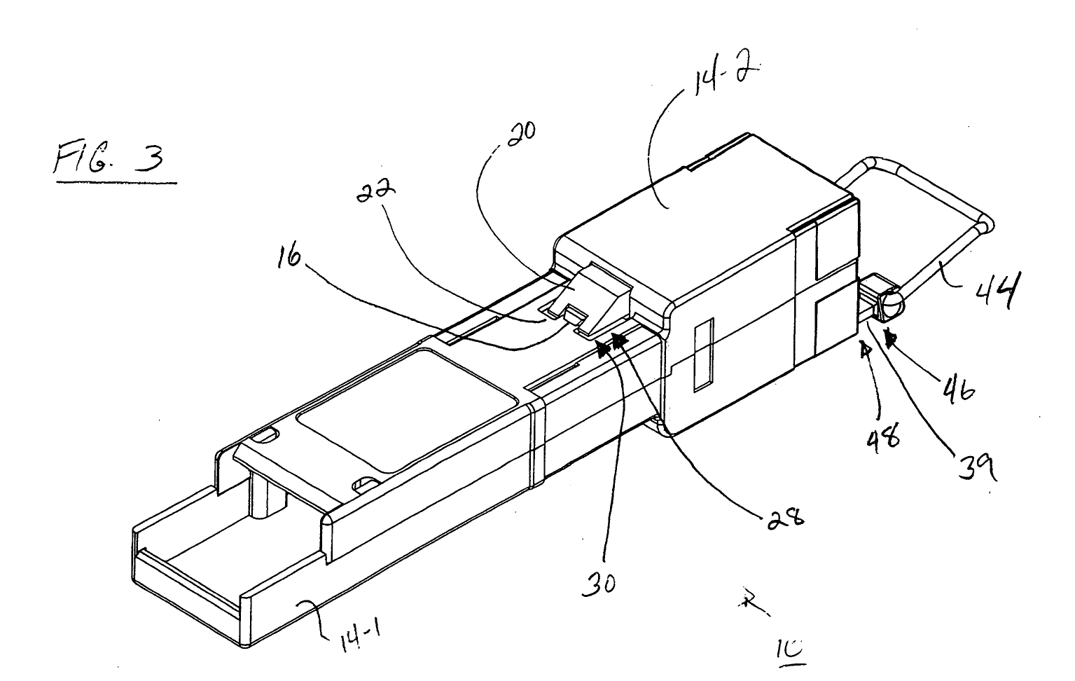

In FIG. 3, the connector module 10 is shown with the pointed end 22 of the wedge member 20 moved to its second position 30. In the preferred embodiment, the second position 30 of the wedge member 28 is where the pointed end 22 of the wedge member 20 is actually past the module locking pin 16. A comparison of FIG. 1 to FIG. 3 reveals that as the bail handle 44 is moved from its first position 46 to its second position 48, the wedge member 20 moved from its first position 28 to its second position 30, i.e., past the module locking pin 16. In FIG. 3, the bail handle 44 is in a nearly horizontal position and it has moved from its first position, identified by reference numeral 46 to its second position identified by reference numeral 48. The horizontal translation of the tie bars 39 that are pulled by the bail handle 44 has caused the wedge member 20 to move from its first position to its second position.

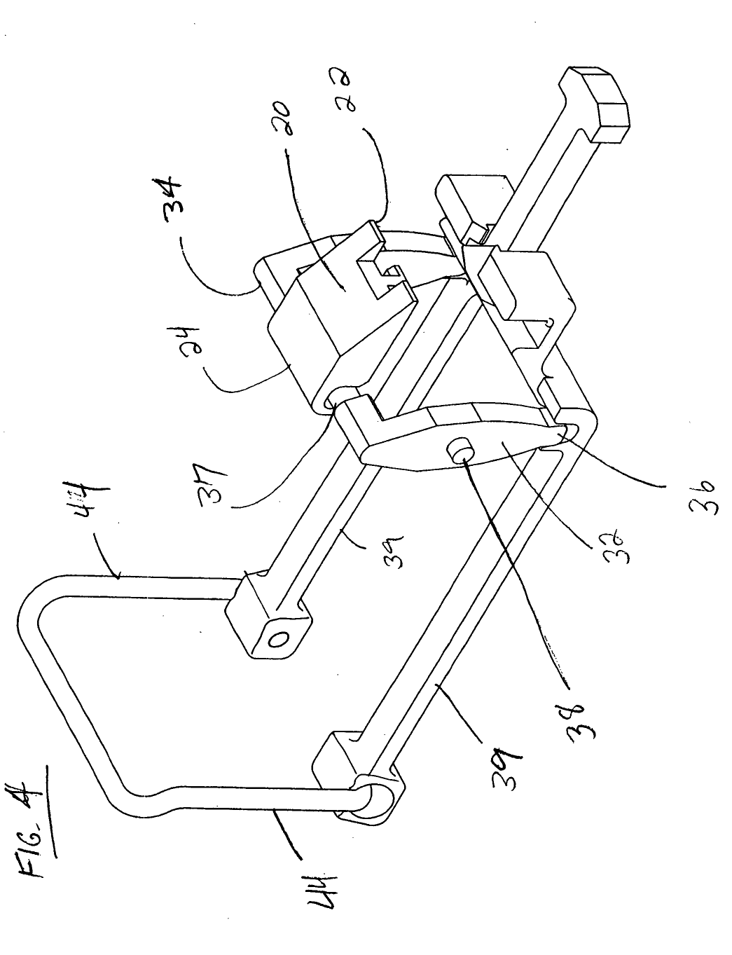

FIG. 4 shows the structure of the de-latching mechanism, such as bail handle 44, lever 32, wedge member 20 and two tie bars 39 that connect the bail handle 44 to the movable lever 32, as well as a cross bar 37 that ties the two lever parts together. The structure shown in FIG. 4 provides a mechanism for moving the wedge member 20 between first and second positions, respectively shown in FIG. 1 and FIG. 3, and in doing so, the wedge member moves the shielded housing engagement tab 18 over the locking pin 16. The wedge member 20 may be characterized as generally U-shaped with a slot or opening disposed along its pointed end. This opening partially surrounds and receives the locking pin 16 when the wedge member is moved into contact with the housing engagement tab 18.

Still referring to FIG. 4, the lever 32 pivots on two spindles 38 (only one visible in FIG. 4) which acts as a fulcrum about the lever 32 moves. The spindles 38 fit into complementary and mating journals in the housing 14, but which are not shown in FIG. 4. Movement of the tie bars 39 against the second end 36 of the lever 32 will cause the lever 32 to pivot on the spindles 38 causing the first end of the lever 34 to move the lever 32 from its first position, i.e., where the wedge 20 is located away from the locking pin 16, to the lever's second position, where the first end 34 of the lever 32 pushes on cross bar 37 which rides in the blunt end 24 of the wedge member 20. As the cross bar 37 moves toward the module locking pin 16, the wedge member 20 moves toward the locking pin 16.

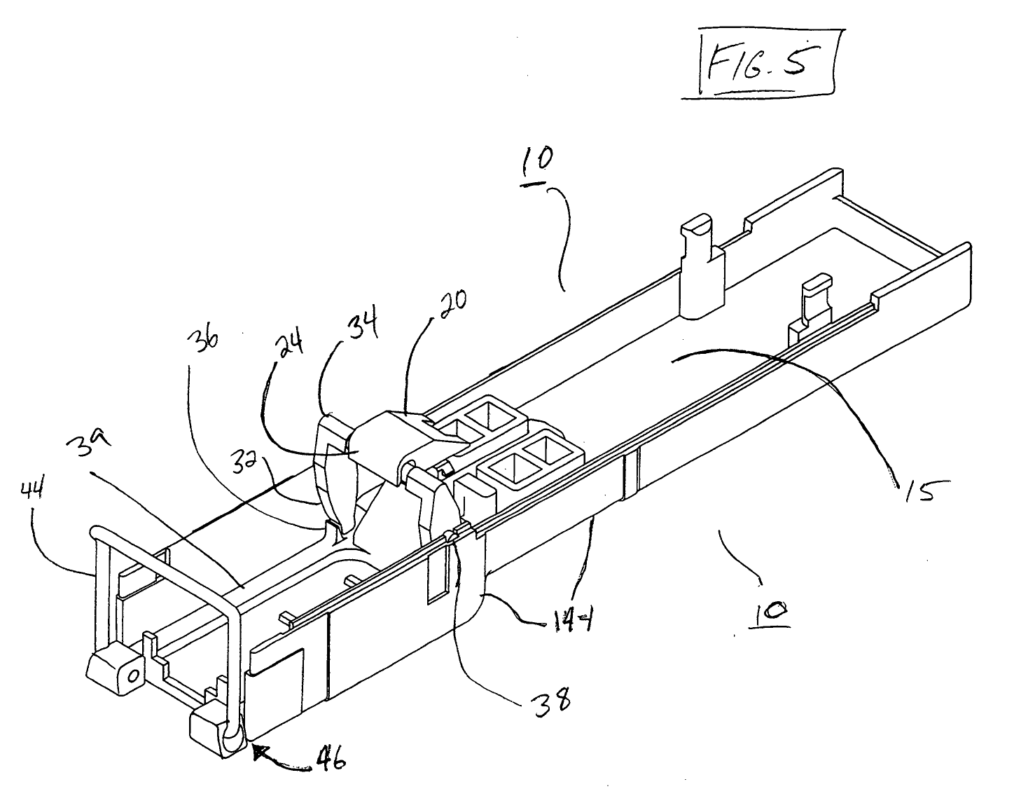

FIG. 5 shows the connector module 10 inverted and with the bottom half 14-2 of the housing body 14 removed to show the hollow interior 15 of the connector module 10. The hollow interior 15 can enclose a circuit board or other electronic device. In this figure, the bail handle is shown in its first position 46. Similarly, the lever 32 is in its first position, which causes the wedge member 20 to be in its first position 28, i.e., away from the locking pin 16, which is not shown in FIG. 5.

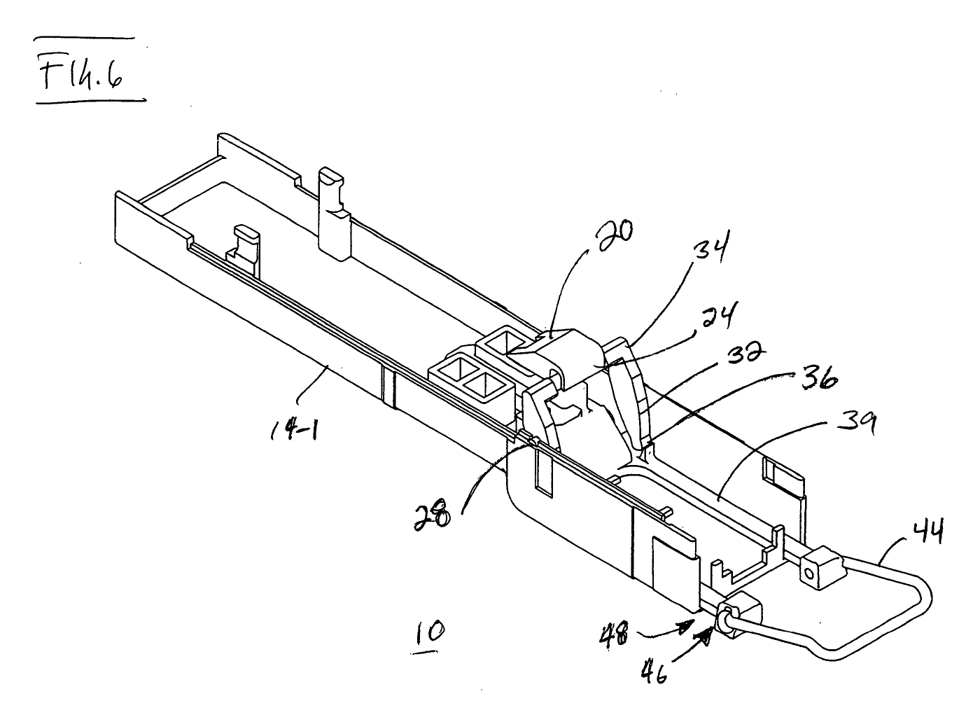

In FIG. 6, the bail handle 44, which is pivotally mounted into the two tie bars 39, is shown moved to a nearly horizontal orientation and pulled away from the housing body 14 to its second position 48. A comparison of two reference numerals 46 and 48 shows that two tie bars 39 and the bail handle 44 are further away from the housing body 14 in FIG. 6 than they are in FIG. 5. As the bail handle 44 is pulled, the tie bar 39 to which it is connected pulls on the second end 36 of the lever 32, thereby causing the lever 32 to move about the fulcrum 28, and in the embodiment shown, this is a pivoting-type of movement. As the second end 36 of the lever 32 moves with the tie bars 39, the first end 34 of the lever 32 moves in the opposite direction, pushing the wedge member 20 toward where the module locking pin 16 is, but which is not shown in FIG. 6 in order to illustrate the action of the lever 32.

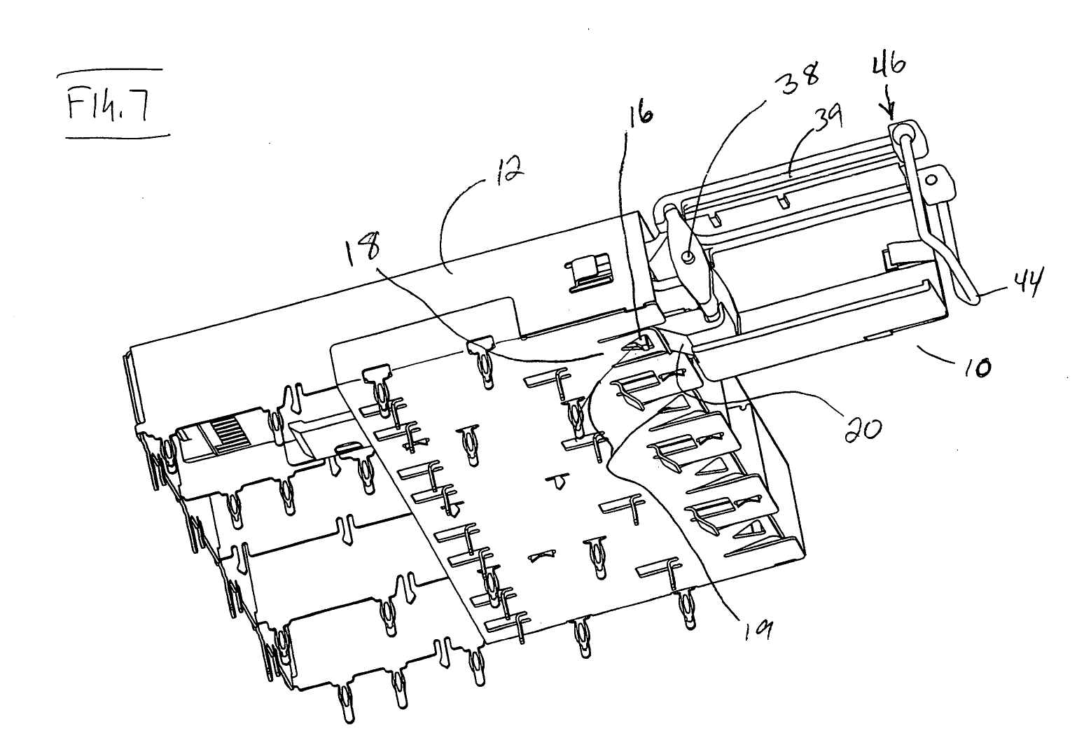

FIG. 7 shows a partial cutaway view of the connector module 10 albeit fully inserted into a shielded housing 12. The module locking pin 16 can be seen extending through the opening 19 in the housing engagement tab 18. The wedge member 20 can also be seen abutting the leading edge of the shielded housing engagement tab 18 but otherwise not lifting the engagement tab 18.

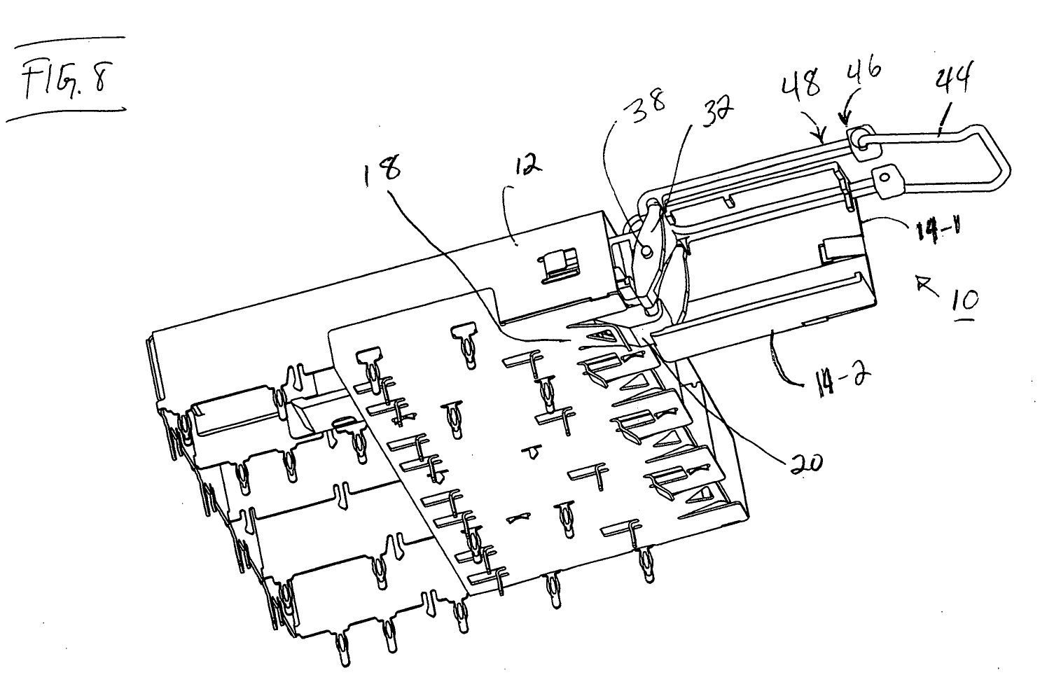

In FIG. 8, the bail handle 44 is moved in a direction away from the connector module 10 and away from the lever 32 and its fulcrum 38, i.e., to the bail handle second position 48. As the bail handle 44 and tie bars 39 move in one direction, the wedge member 20, which is on the opposite end of the lever 32, moves in the opposite direction. Accordingly, when the bail handle 44 moves away from the module locking pin 16, the wedge member 20 moves toward the module locking pin 16. As shown in FIG. 8, movement of the lever 32 about its fulcrum 38 therefore causes the wedge member 20 to slide “under” the engagement tab 18, pushing the engagement tab 18 over the top of the module locking pin 16. In so doing, the module locking pin 16 is freed from the engagement tab 18 thereby enabling the connector module 10 to be removed from the shielded housing 12.

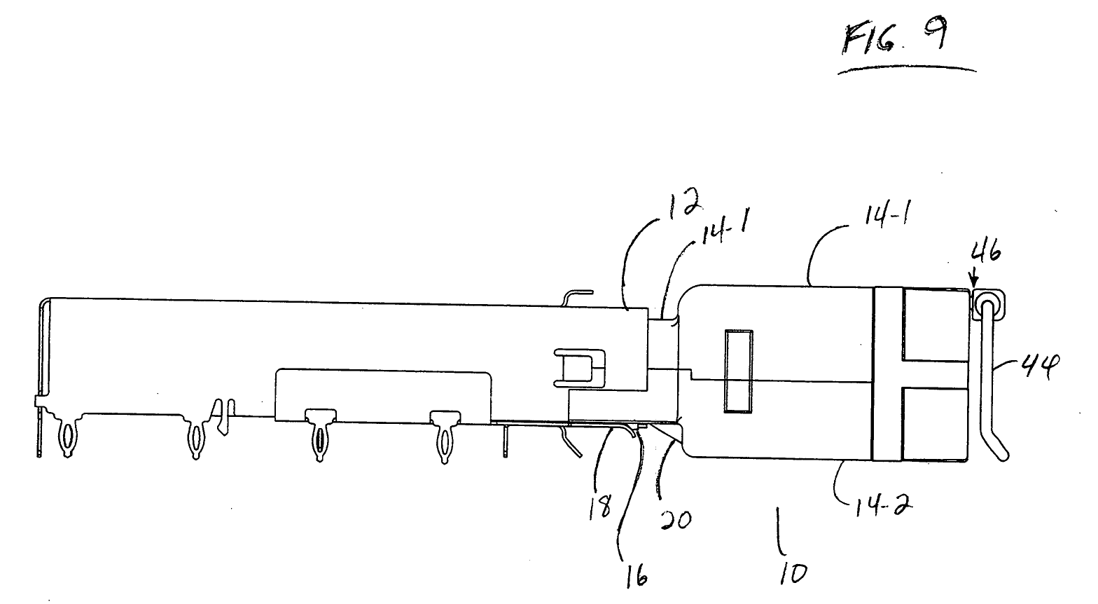

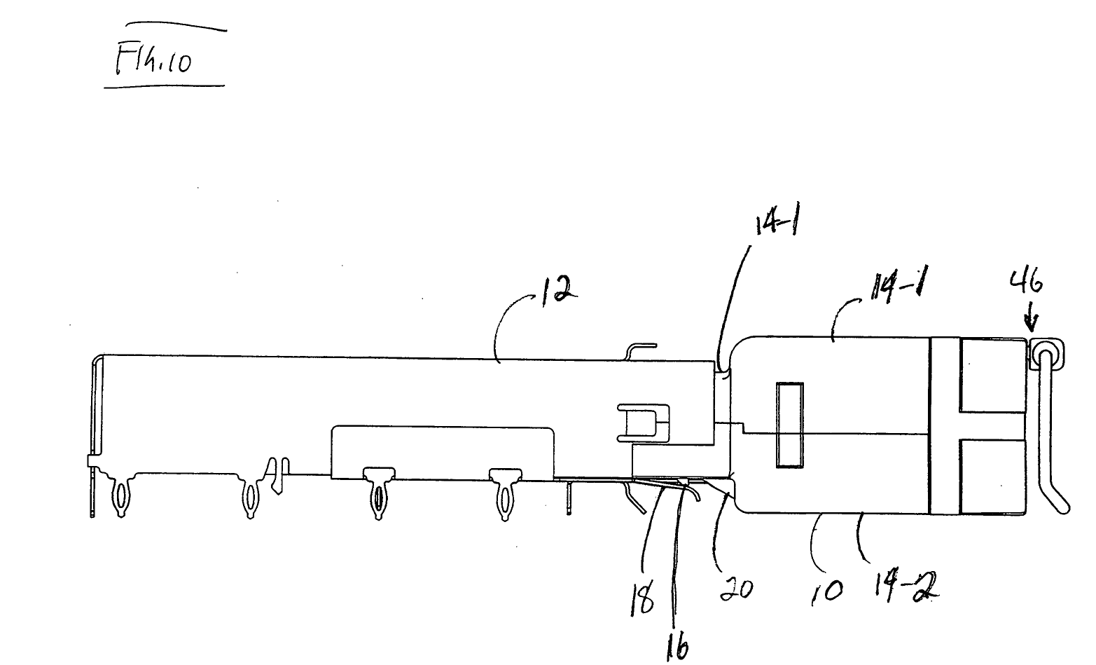

FIG. 9 is a side elevation view showing the connector module 10 only partially inserted into the shielded housing 12. This Figure clearly shows the module locking pin 16 just beginning to engage the engagement tab 18. The wedge member 20 is also shown in its first position, i.e., away from the locking pin 16. In FIG.10, the connector module 10 is partially inserted into the shielded housing 12. As shown, the module locking pin 16 has slid “above” the engagement tab 18, causing it to deflect downwardly in response to the horizontal movement of the module locking pin 16 into the shielded housing 12. The depiction of FIG. 10 can also be described as showing the engagement tab 18 sliding over the module locking pin 16. In either case, the module locking pin 16 will engage the engagement tab 18 when the connector module 10 is fully inserted into the exterior housing 12.

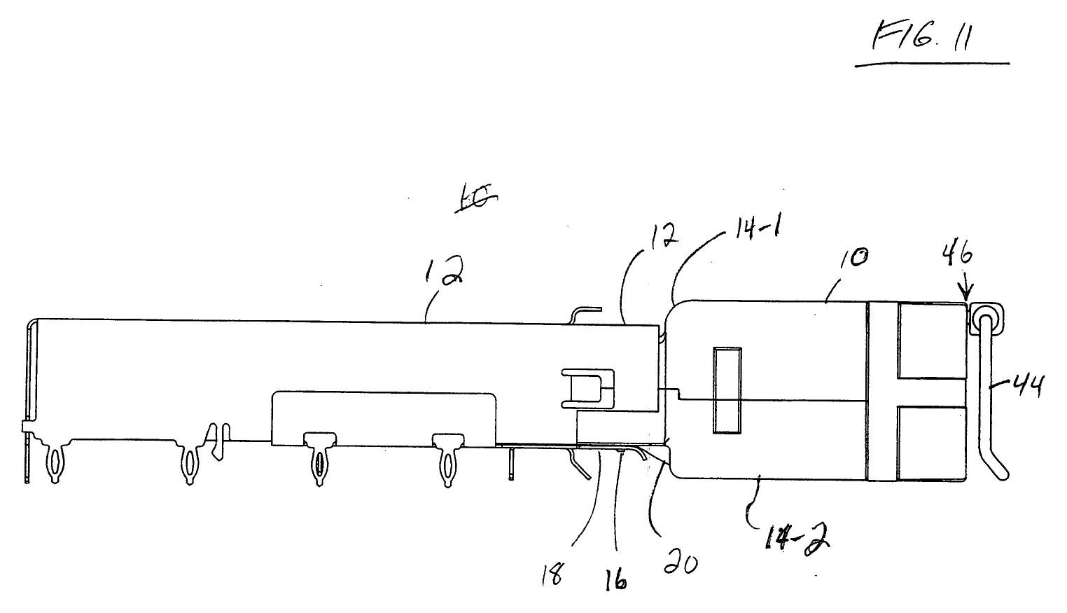

In FIG. 11, the connector module 10 is shown fully inserted into the shielded housing 12. In this Figure, the module locking pin 16 can be seen to be extending through an opening in the engagement tab 18 thereby latching, i.e., locking, the connector module 10 in place within the exterior shielded housing 12. With the wedge member 20 in its first position, as is the bail handle 44 and the pull arm, the connector 10 is fully latched into the housing.

As can be seen in FIG. 1, the wedge member 20 is a U-shaped wedge, the legs of which will straddle the locking pin when the wedge member 20 is moved from its first position 28 to its second position 30. Altered embodiments of the wedge member 20 would certainly include other wedge shapes so long as the wedge member is able to move or “lift” the flexible engagement tab 18 of the exterior shielded housing over the end of the module locking pin 16 so that the module locking pin 16 can clear the engagement tab 18 as the connector module 10 is urged out of and away from the shielded housing 12.

As is also shown in FIG. 1, the elongated housing body 14 has a first end 11 and a second end 13. Inasmuch as the housing body 14 is hollow, as shown in FIG. 5 and FIG. 6, the housing body can accommodate electronics or a circuit board. In a preferred embodiment, the second end 13 of the housing body 14 accommodates an RJ-45 connector receptacle. In such an embodiment, RJ-45 connectors can be plugged into the connector module 10, which can in turn be plugged into the shielded housing 12 thereby forming a removable connector system. In such an embodiment, the second end 13 of the housing body 14 can be considered to be a port that encloses a standardized receptacle such as an RJ-45 or RJ-11 connector. Although it is not shown in any of the figures, as is well-known with plug-in modules, the edge connector terminals of a circuit board in the housing interior 15 can be made to extend past the first end 11 of the housing to allow the connector 10 module to be plugged into a connector in the shielded housing 12. The end of the circuit board opposite the edge connector terminals can be wired to the terminals of the aforementioned RJ-45 and RJ-11 connectors.

In the preferred embodiment, the shielded housing 12 is sheet metal. The connector module body halves 14-1 and 14-2 may be cast alloys. The bail handle 44 is formed from rigid wire. The lever 32 may be plastic as is the tie bars 39 and the cross bar 37, and it is preferred that the tie bars are resilient in nature because some measure of stretching may be involved in their operation. The wedge member may be a cast metal alloy. Alternate embodiments of the invention use plastic and/or metal plated plastic, all of which are equivalent for purposes of claim construction.

From the foregoing it should be apparent that a readily releaseable connector assembly that affords easy removal from a connector-latching housing is provided by a simple lever and fulcrum mechanism within the connector. A displacement of the lever can move a wedge member between an engagement tab and a locking pin, releasing the engagement tab from its engagement with the locking pin.

While the preferred embodiment of the invention have been shown and described, it will be apparent to those skilled in the art that changes and modifications may be made therein without departing from the spirit of the invention, the scope of which is defined by the appended claims

1. A connector module for use with an exterior housing, the connector module comprising:
a body having a locking member protruding from the body in order to engage a flexible tab disposed in the exterior housing;
at least one wedge member including a pointed end facing said body locking member and a blunt end of a predetermined height, the wedge member being movable between a first position wherein the pointed end is spaced apart from said body locking member and a second position wherein said wedge member pointed end engages the exterior housing flexible tab and lifts said exterior housing flexible tab above said body locking member;
a lever disposed within said body, the lever including first and second ends, said lever moving about a fulcrum within said body, the lever first end being operatively connected to the wedge member blunt end and sliding said wedge member between said first and second positions as said lever is moved about said fulcrum between first and second lever positions, the lever second end being operatively connected to a bail handle exterior of said connector module, such that movement of said lever, by way of said bail handle, to said lever first position results in said wedge member being disposed away from said member, and movement of said lever, by way of said bail handle to said lever second position, moves said wedge member pointed end toward said locking member into contact with said housing engagement tab to move said engagement tab out of engagement with said locking member.

2. The connector module of claim 1, wherein said wedge is a U-shaped wedge that fits around said locking member.

3. The connector module of claim 2, wherein said lever second position moves said U-shaped wedge member pointed end past said locking member.

4. A connector system comprising:
a shielded housing having an opening, sized and shaped to receive a mating connector module, the shielded housing including a flexible engagement tab for engaging a locking pin on the mating connector module;
a connector module having first and second ends, the connector module being sized and shaped to be received in the opening of said shielded housing, said connector module further including a port disposed in the first end there, the port defining a receptacle, a circuit board disposed in said connector module, the circuit board protruding partially from the connector second end, said connector module further including a locking member that extends out from said connector module, the locking member engaging said shielded housing engagement tab to latch said connector module in place with said shielded housing;
a de-latching mechanism including a U-shaped wedge member, the wedge member having opposing pointed and blunt ends and a notch disposed along its pointed end to define the U-shape of said wedge member, said wedge member being disposed exterior of said connector module and further being movable between first and second position, wherein in the first position, said wedge member pointed end is disposed away from said locking member, and in said second position, said wedge member pointed end is disposed proximate to and partially around said locking member movement, that an inclined face of said wedge member engages said housing engagement tab to move said housing engagement tab out of engagement with said housing engagement tab, the de-latching mechanism further including a lever and a fulcrum, the lever being rotatable between first and second operative positions, said lever including first and second ends, said lever being supported by said connector module for rotational movement around the fulcrum, the lever first end being operatively connected to the wedge member blunt end and the lever second end being operatively connected to a handle disposed exterior of said connector module and proximate to said port, said lever being rotatable about said fulcrum in response to lateral movement of the handle, whereby when said lever is in said first operable position, said wedge member is disposed away from said locking member, and when said lever is in said second operative position, said wedge member is disposed close to and partially surrounding said locking member, whereby movement of said wedge member from said first to said second operative position causes said engagement tab to move out of engagement with said connector module locking member, thereby de-latching said connector module from said shielded housing.
